(19) United States
(12) Patent Application Publication
(10) Pub. No.: US 2026/0202545 A1
(43) Pub. Date: Jul. 16, 2026

(54) LIGHT DETECTION AND RANGING SENSOR MOUNTED ON MOBILE ROBOT AND LIGHT DETECTION AND RANGING SENSING METHOD PERFORMED BY LIGHT DETECTION AND RANGING SENSOR

(71) Applicant: ELECTRONICS AND TELECOMMUNICATIONS RESEARCH INSTITUTE, Daejeon (KR)

(72) Inventors: Suseong KIM, Daejeon (KR); Sanghyouk CHOI, Daejeon (KR); Youngsun KWON, Daejeon (KR); Myung Seok KI, Daejeon (KR); Yunsu BOK, Daejeon (KR); Ji Hwan SON, Daejeon (KR); Younghun JOHN, Daejeon (KR); You Kyung HONG, Daejeon (KR)

(21) Appl. No.: 19/349,126

(22) Filed: Oct. 3, 2025

(30) Foreign Application Priority Data
Jan. 10, 2025 (KR) 10-2025-0004256

(51) Int. Cl. G01S 17/89; G01S 7/51; G01S 17/933

(52) U.S. Cl. CPC G01S 17/89; G01S 7/51; G01S 17/933

(57) ABSTRACT

The present disclosure relates to a light detection and ranging (LiDAR) sensing method using a computing device included in a LiDAR sensor that moves while mounted on a mobile robot. The computing device removes interference from scan data collected by the LiDAR sensor, manages and merges matching data and proximity point data, and visually outputs results that simulate a real environment on a display.

### CROSS-REFERENCE TO RELATED APPLICATION

This application claims the benefit of Korean Patent Application No. 10-2025-0004256, filed on Jan. 10, 2025, in the Korean Intellectual Property Office, the entire disclosure of which is incorporated herein by reference for all purposes.

### BACKGROUND

### 1. Field of the Invention

One or more embodiments relate to a light detection and ranging (LiDAR) sensor and a LiDAR sensing method performed by the LiDAR sensor.

### 2. Description of the Related Art

A LiDAR sensor is a sensor that is widely used in various fields such as industrial robots, mobile robots, and autonomous vehicles. However, since the basic minimum measurement distance of the LiDAR sensor is set to 0.5 meters (m) or within a radius of 0.2 m, the LiDAR sensor has a problem in that the sensing accuracy for objects in the vicinity is low. In other words, since the accuracy of the sensing result of the LiDAR sensor decreases near the minimum measurement distance set for the LiDAR sensor, a measurement value may be distorted and modified when there is an obstacle in the vicinity of a mobile robot.

In addition, the LiDAR sensor may not move independently, so the LiDAR sensor may be mounted on a separate device such as a drone to perform scanning, which causes the measurement value of the LiDAR sensor to be distorted and omitted, differing from an actual value depending on the position where the LiDAR sensor is mounted or the degree of proximity to a flat obstacle. When the LiDAR sensor is mounted on a mobile robot, there may be a problem in processing the shape information of objects near the minimum measurement distance of the LiDAR sensor, such as a mobile robot body, adjacent obstacles, and the like.

### SUMMARY

Embodiments provide a light detection and ranging (LiDAR) sensing method that improves the sensing accuracy of an obstacle existing within a very close range or a short range of a LiDAR sensor by compensating for scan data of a shaded region that may be generated in a sensing range of the LiDAR sensor mounted on a mobile robot.

Embodiments provide the LiDAR sensing method that may be utilized for various purposes such as environmental analysis, object recognition, robot adjacent obstacle avoidance, and impact detection and analysis in a complex environment such as a region crowded with obstacles by providing scan data with improved sensing accuracy of the LiDAR sensor to a user.

According to an aspect, there is provided a computing device including a scan trimming module configured to collect scan data at a current point in time scanned through a LiDAR sensor mounted on a mobile robot and remove interference data included in the scan data at the current point in time, a scan manager module configured to manage at least one of the scan data at the current point in time with the interference data removed and matching data at a past point in time, a scan matching module configured to generate matching data at a current point in time that indicates a position and a posture of the LiDAR sensor in a reference coordinate system according to a point in time at which the LiDAR sensor collects the scan data at the current point in time, a proximity point manager module configured to determine, using the scan data at the current point in time with the interference data removed, proximity point data included in a sensing range with respect to the position of the LiDAR sensor, a scan merging module configured to merge, based on the matching data at the current point in time, the proximity point data with the scan data at the current point in time with the interference data removed, and a LiDAR-like scan module configured to process merged scan data to simulate scan result data and visually output a simulated result on a screen.

The scan trimming module may be configured to collect, from the LiDAR sensor, scan data at a current point in time obtained by scanning a dynamic environment that changes according to movement of the mobile robot within a sensing range of the LiDAR sensor.

The scan trimming module may be configured to remove, from a point cloud included in the scan data at the current point in time, an overlapping point, which is identified as interference data, between a main body of the mobile robot and sensor data of the LiDAR sensor.

The scan trimming module may be configured to remove, from a point cloud included in the scan data at the current point in time, a predetermined point, which is identified as interference data and included in the sensing range of the LiDAR sensor, by considering an external variable according to the dynamic environment.

The scan matching module may be configured to generate matching data at a current point in time that indicates the position and the posture of the LiDAR sensor for reference fixed coordinates (an inertial frame) when the LiDAR sensor scans the scan data at the current point in time.

The proximity point manager module may be configured to, using the scan data at the current point in time with the interference data removed and the matching data at the current point in time, convert, into coordinates of a reference fixed coordinate (inertial frame) system, a point cloud included in the scan data at the current point in time with the interference data removed and accumulate the point cloud on a reference coordinate system, and determine proximity point data by extracting a point cloud within a predetermined range with respect to the position of the LiDAR sensor in the reference coordinate system on which the point cloud is accumulated.

The proximity point manager module may be configured to, using the matching data at the current point in time, determine the position of the LiDAR sensor at a point in time at which the LiDAR sensor collects the scan data at the current point in time and determine proximity point data such that a point cloud is included in a preset or predetermined range with respect to the position of the LiDAR sensor on the reference coordinate system on which the converted point cloud is accumulated.

The proximity point manager module may be configured to extract, from the scan data at the current point in time, with the interference data removed, scanned when a driving distance of the mobile robot is less than or equal to a preset or predetermined distance among the scan data at the current point in time with the interference data removed, a point cloud, convert the point cloud into the coordinates of the inertial frame system, and accumulate the point cloud on the reference coordinate system.

The scan merging module may be configured to, using the matching data at the current point in time, determine the position and the posture of the LiDAR sensor at the current point in time, convert a point cloud included in the proximity point data into coordinates of a body coordinate system of the LiDAR sensor according to the position and the posture of the LiDAR sensor at the current point in time, and generate scan result data by merging the scan data at the current point in time with the interference data removed with the point cloud converted into the coordinates of the body coordinate system of the LiDAR sensor.

The LiDAR-like scan module may be configured to convert a point cloud included in the scan result data into coordinates of a spherical coordinate system, assign points included in the point cloud, which is converted into the coordinates of the spherical coordinate system, to elevation-azimuth grids in a one-to-one manner, wherein the elevation-azimuth grids are set as specifications (intrinsic parameters) of the LiDAR sensor, and using the points assigned to the elevation-azimuth grids in a one-to-one manner, visually output the scan result data on a screen.

According to another aspect, there is provided a mobile robot including a main body, a LiDAR sensor mounted on a first predetermined region of the main body, and other sensors mounted on a second predetermined region of the main body, wherein the LiDAR sensor may be configured to derive, visually compensate for, and output scan data of a shaded region that is possibly generated in a sensing range of the LiDAR sensor by scanning scan data at a current point in time in a dynamic environment that changes according to movement of the mobile robot.

The LiDAR sensor may include a computing device including a processor, and the processor may include a LiDAR sensor module configured to collect scan data at a current point in time scanned through the LiDAR sensor mounted on the mobile robot, a scan trimming module configured to remove interference data included in th e scan data at the current point in time, a scan manager module configured to manage at least one of the scan data at the current point in time with the interference data removed and matching data at a past point in time, a scan matching module configured to generate matching data at a current point in time that indicates a position and a posture of the LiDAR sensor in a reference coordinate system according to a point in time at which the LiDAR sensor collects the scan data at the current point in time, a proximity point manager module configured to determine, using the scan data at the current point in time with the interference data removed, proximity point data included in a sensing range with respect to the position of the LiDAR sensor according to the movement of the mobile robot, a scan merging module configured to merge, based on the matching data at the current point in time, the proximity point data with the scan data at the current point in time with the interference data removed, and a LiDAR-like scan module configured to process merged scan data to simulate scan result data and visually output a simulated result on a screen.

According to another aspect, there is provided a LiDAR sensing method performed by a computing device, the LiDAR sensing method including collecting scan data at a current point in time at which a dynamic environment that changes according to movement of a mobile robot is scanned within a sensing range of a LiDAR sensor through the LiDAR sensor mounted on the mobile robot, removing interference data included in the scan data at the current point in time, using matching data at a past point in time, storing and managing at least one of the interference data and the matching data at the past point in time, generating matching data at a current point in time that indicates a position and a posture of the LiDAR sensor in a reference coordinate system according to a point in time at which the LiDAR sensor collects the scan data at the current point in time, using the scan data at the current point in time with the interference data removed, determining proximity point data included in a sensing range with respect to the position of the LiDAR sensor according to the movement of the mobile robot, based on the matching data at the current point in time, merging the proximity point data with the scan data at the current point in time with the interference data removed, and processing merged scan data to simulate scan result data and visually outputting a simulated result on a screen.

The removing of the interference data may include removing, from a point cloud included in the scan data at the current point in time, an overlapping point, which is identified as interference data, between a main body of the mobile robot and sensor data of the LiDAR sensor.

The removing of the interference data may include removing, from a point cloud included in the scan data at the current point in time, a predetermined point included in a sensing range of the LiDAR sensor and identified as interference data by considering an external variable according to the dynamic environment.

The generating of the matching data at the current point in time may include generating the matching data at the current point in time that indicates a position and a posture of the LiDAR sensor for an inertial frame when the LiDAR sensor scans the scan data at the current point in time.

The determining of the proximity point data may include, using the matching data at the current point in time, determining the position of the LiDAR sensor at a point in time at which the LiDAR sensor collects the scan data at the current point in time, using the scan data at the current point in time with the interference data removed and the matching data at the current point in time, converting, into coordinates of an inertial frame system, a point cloud included in the scan data at the current point in time with the interference data removed and accumulating the point cloud on a reference coordinate system, and determining proximity point data so that a point cloud within a preset or predetermined range with respect to the position of the LiDAR sensor is included in the reference coordinate system on which the point cloud is accumulated.

The extracting of a first point cloud may include extracting, from the scan data at the current point in time, with the interference data removed, scanned when a driving distance of the mobile robot is less than or equal to a preset or predetermined distance among the scan data at the current point in time with the interference data removed, a point cloud, converting the point cloud into the coordinates of the inertial frame system, and accumulating the point cloud on the reference coordinate system.

The generating of the scan result data may include, using the matching data at the current point in time, determining a position and a posture of the LiDAR sensor at the current point in time, converting a point cloud included in the proximity point data into coordinates of a body coordinate system of the LiDAR sensor according to the position and the posture of the LiDAR sensor at the current point in time, and generating the scan result data by merging the point cloud converted into the coordinates of the body coordinate system of the LiDAR sensor with the scan data at the current point in time with the interference data removed.

The outputting of the simulated result may include converting the point cloud included in the scan result data into coordinates of a spherical coordinate system, assigning points included in the point cloud, which is converted into the coordinates of the spherical coordinate system, to elevation-azimuth grids in a one-to-one manner, wherein the elevation-azimuth grids are set as intrinsic parameters of the LiDAR sensor, and using the points assigned to the elevation-azimuth grids in a one-to-one manner, visually outputting the scan result data on a screen.

Additional aspects of embodiments will be set forth in part in the description which follows and, in part, will be apparent from the description, or may be learned by practice of the disclosure.

According to an embodiment, by compensating for scan data of a shaded region that may be generated in a sensing range of a LiDAR sensor that moves while mounted on a mobile robot, the sensing accuracy of the LiDAR sensor for an obstacle existing within a very close range or a short distance may be improved.

According to an embodiment, by providing scan data with improved sensing accuracy of the LiDAR sensor to a user, usability may be increased for various purposes such as environmental analysis, object recognition, robot adjacent obstacle avoidance, and impact detection and analysis in a complex environment such as a region crowded with obstacles.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an operation of providing scan result data through a light detection and ranging (LiDAR) sensor that moves while mounted on a mobile robot, according to an embodiment;

FIG. 2 is a diagram illustrating a detailed operation of a computing device included in a LiDAR sensor, according to an embodiment;

FIG. 3 is a diagram illustrating an operation of a LiDAR sensor module of a computing device, according to an embodiment;

FIG. 4 is a diagram illustrating an operation of a scan trimming module of a computing device, according to an embodiment;

FIGS. 5A and 5B are diagrams illustrating a detailed operation of a scan trimming module, according to an embodiment;

FIG. 6 is a diagram illustrating an operation of a scan manager module of a computing device, according to an embodiment;

FIG. 7 is a diagram illustrating an operation of a scan matching module of a computing device, according to an embodiment;

FIG. 8 is a diagram illustrating an operation of a proximity point manager module of a computing device, according to an embodiment;

FIG. 9 is a diagram illustrating an operation of a scan merging module of a computing device, according to an embodiment;

FIG. 10 is a diagram illustrating an operation of a LiDAR-like scan module of a computing device, according to an embodiment;

FIGS. 11A and 11B are diagrams illustrating results provided through a LiDAR-like scan module, according to an embodiment; and

FIG. 12 is a block diagram illustrating an example of a configuration of a computing device included in a LiDAR sensor, according to an embodiment.

### DETAILED DESCRIPTION

Hereinafter, embodiments are described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

The same name may be used to describe an element included in the embodiments described above and an element having a common function. Unless stated otherwise, the description of an embodiment may be applicable to other embodiments, and a repeated description related thereto is omitted.

A light detection and ranging (LiDAR) sensing method performed by a computing device of a LiDAR sensor described in the present disclosure is a method of improving the sensing accuracy of the LiDAR sensor by deriving scan data of a possible shaded region in the sensing range of the LiDAR sensor using scan data at a current point in time sensed according to the movement of a mobile robot through a single LiDAR sensor mounted on the mobile robot and previously obtained scan data at a past point in time and visually compensating for the scan data.

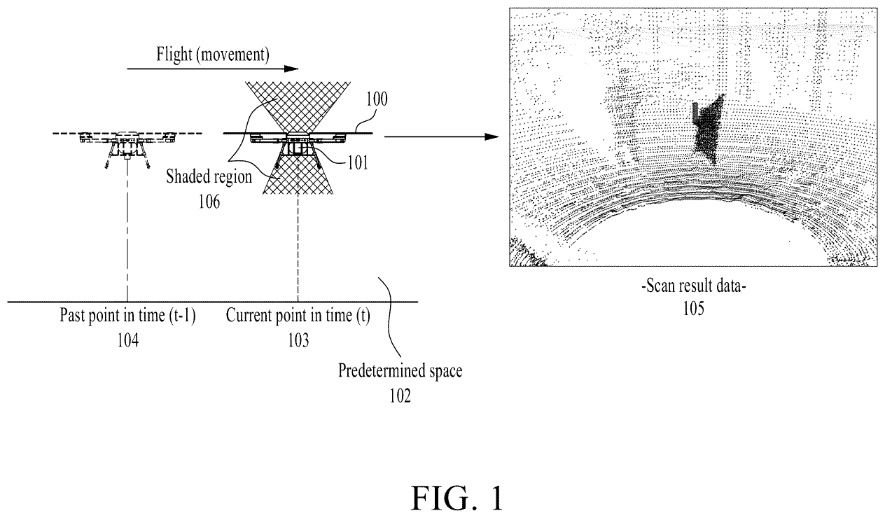

FIG. 1 is a diagram illustrating an operation of providing scan result data through a LiDAR sensor that moves while mounted on a mobile robot, according to an embodiment.

Referring to FIG. 1, a LiDAR sensor 101 may be mounted on a mobile robot 100. The mobile robot 100 may be an unmanned aerial vehicle that is automatically controlled by an autonomous navigation device or remotely controlled using radio waves. For example, the mobile robot 100 may include a drone, an unmanned aerial vehicle, an unmanned vehicle, and the like. The mobile robot 100 may fly at a constant velocity per unit time and move across a predetermined space 102.

The LiDAR sensor 101 may be moved by the movement of the mobile robot 100 while mounted on the mobile robot 100. The LiDAR sensor 101 may generate scan data by scanning a dynamic environment that changes according to the movement of the mobile robot 100 within the sensing range of the LiDAR sensor 101.

The LiDAR sensor 101 may measure the distance, direction, velocity, and the like of an object existing in the dynamic environment depending on the modulation method. The modulation method may include a time of flight (TOF) technique or a phase-shift technique. Scan data may be point cloud data, which is a collection of points in a three-dimensional (3D) space. For example, the LiDAR sensor 101 may be a rotational LiDAR sensor.

As the position of the LiDAR sensor 101 is changed by the mobile robot 100, scan data at a past point in time 104 and scan data at a current point in time 103 may be generated according to each changed position.

Here, the present disclosure provides a dead zone, that is, a shaded region 106 above and below the mobile robot 100 on which the LiDAR sensor 101 is mounted or the LiDAR sensor 101 according to the sensing range of the LiDAR sensor 101. The shaded region 106 may be a region that does not fall within the sensing range of the LiDAR sensor 101 and may include a very close range or a short range.

Accordingly, the LiDAR sensor 101 may derive scan data related to the shaded region 106 generated during a sensing process by utilizing the scan data at the past point in time 104 based on the scan data at the current point in time 103. The LiDAR sensor 101 may generate merged scan data including not only long-distance scan data but also very close range or short range scan data based on the position of the mobile robot 100 by deriving the scan data related to the shaded region 106. The LiDAR sensor 101 may process the merged scan data to simulate scan result data 105 and visually provide a simulated result to a user.

Therefore, when the mobile robot 100 on which the LiDAR sensor 101 is mounted is deployed in an environment with a dense obstacle population and the like, the LiDAR sensor 101 may accurately measure and provide not only long-distance region information of the mobile robot 100 but also very close range region information, so the present disclosure may further increase the usability of the LiDAR sensor 101 in various areas such as object detection, obstacle management, and impact detection and analysis when the mobile robot 100 operates.

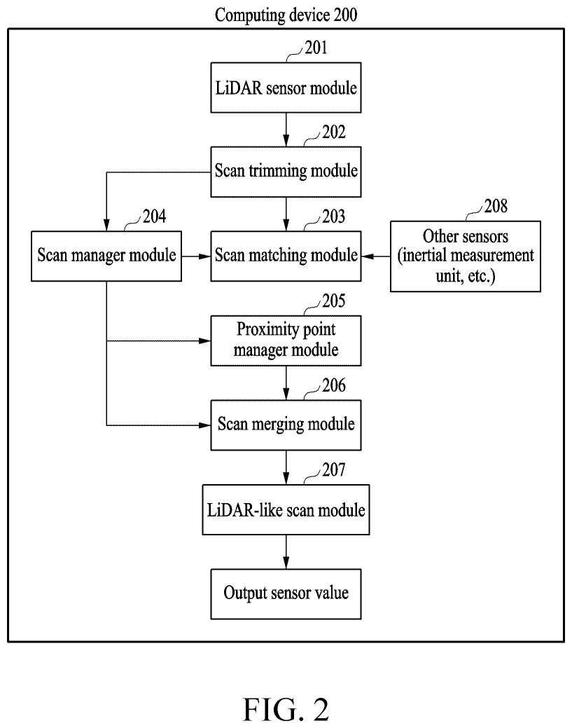

FIG. 2 is a diagram illustrating a detailed operation of a computing device included in a LiDAR sensor, according to an embodiment.

Referring to FIG. 2, the LiDAR sensor 101 may include a computing device 200, and the computing device 200 may include a processor. The processor may include a memory, and the computing device 200 may be executed by a program stored in the memory.

The computing device 200 may perform a LiDAR sensing method to improve the sensing accuracy of an obstacle existing within a very close range or a short range of the LiDAR sensor 101.

The computing device 200 may include a plurality of modules. The plurality of modules may include a LiDAR sensor module 201, a scan trimming module 202, a scan matching module 203, a scan manager module 204, a proximity point manager module 205, a scan merging module 206, and a LiDAR-like scan module 207.

The LiDAR sensor module 201 may collect scan data at a current point in time at which a surrounding environment of the LiDAR sensor 101 mounted on the mobile robot 100 is scanned. The LiDAR sensor module 201 may transmit the collected scan data at the current point in time to the scan trimming module 202. The current point in time may be a point in time t.

The scan trimming module 202 may receive the scan data at the current point in time from the LiDAR sensor module 201 and remove interference data included in the scan data at the current point in time. The scan trimming module 202 may transmit the scan data at the current point in time with the interference data removed to the scan matching module 203 and the scan manager module 204.

The scan matching module 203 may generate matching data at the current point in time that indicates a position and a posture of the LiDAR sensor in a reference coordinate system according to a point in time at which the LiDAR sensor collects the scan data at the current point in time. For example, the scan matching module 203 may generate the matching data at the current point in time by matching a key frame with the scan data at the current point in time with the interference data removed. The scan matching module 203 may be linked with other sensors 208 to improve the accuracy of the matching data.

The scan manager module 204 may store and manage the scan data with the interference data removed and may store and manage matching data of each scan data. The scan manager module 204 may perform a function of transmitting the stored and managed scan data and matching data to the proximity point manager module 205 and the scan merging module 206.

In addition, the scan manager module 204 may determine a key frame that is a basis for the movement of the mobile robot 100 among the scan data at the current point in time with the interference data removed received from the scan trimming module 202 using matching data at a past point in time generated in the past through the scan matching module 203. The past point in time may be a point in time t−1.

The proximity point manager module 205 may determine proximity point data included in the sensing range of the LiDAR sensor according to the movement of the mobile robot 100 using the matching data at the current point in time generated by the scan matching module 203.

The scan merging module 206 may merge proximity point data with the scan data at the current point in time with the interference data removed based on the matching data at the current point in time.

The LiDAR-like scan module 207 may process the merged scan data, which is merged by the scan merging module 206, to simulate scan result data and may visually output a simulated result on a screen.

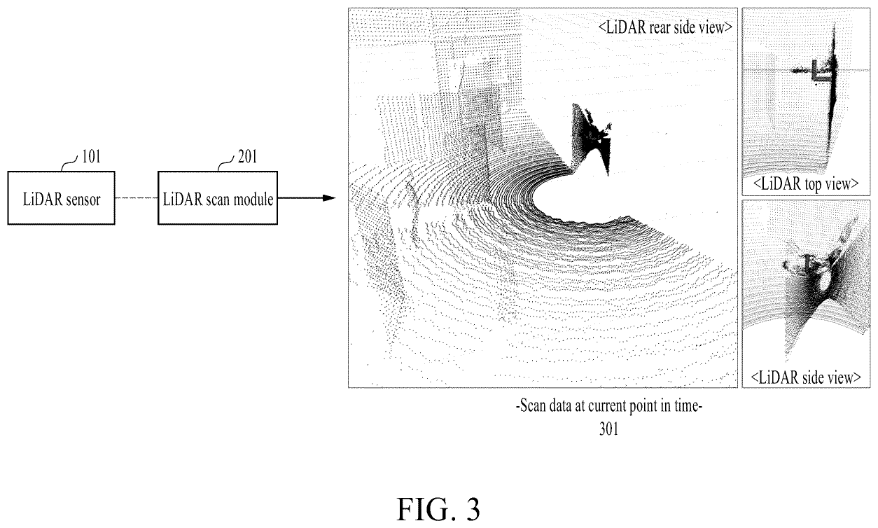

Each of the plurality of modules described above is described in greater detail with reference to FIGS. 3 to 11.

FIG. 3 is a diagram illustrating an operation of a LiDAR sensor module of a computing device, according to an embodiment.

Referring to FIG. 3, the LiDAR sensor module 201 may collect scan data 301 at a current point in time at which a surrounding environment of the LiDAR sensor 101 mounted on the mobile robot 100 is scanned. In other words, the LiDAR sensor module 201 may collect the scan data 301 at the current point in time at which a dynamic environment that changes according to the movement of the mobile robot 100 within the sensing range of the LiDAR sensor 101 is scanned from the LiDAR sensor 101. The LiDAR sensor module 201 may collect scan data related to a space through rotational scanning for a field of view in a predetermined direction.

The scan data 301 at the current point in time may be the result of scanning the surrounding environment with respect to the LiDAR sensor 101 according to the field of view in the predetermined direction. For example, the scan data 301 at the current point in time may include a LiDAR rear side view, a LiDAR top view, and a LiDAR side view.

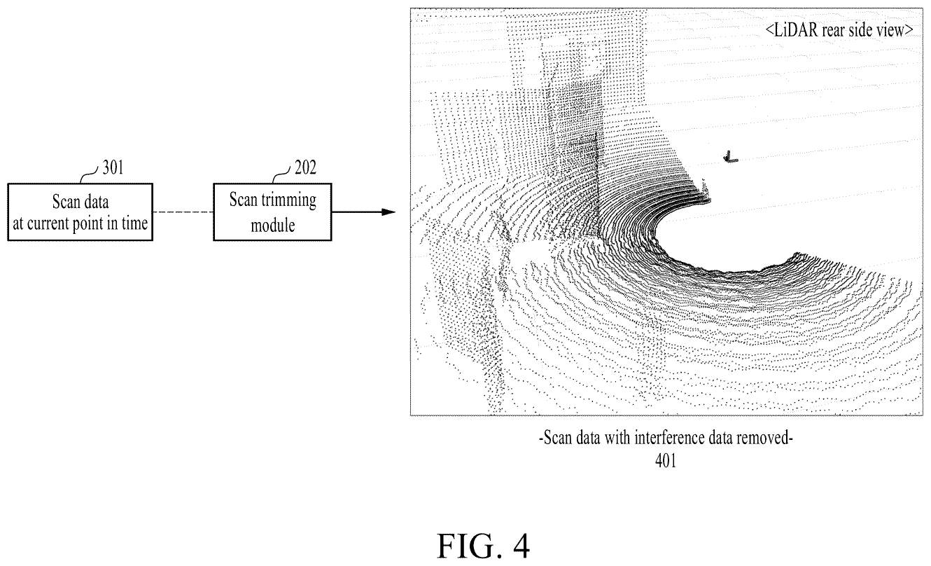

FIG. 4 is a diagram illustrating an operation of a scan trimming module of a computing device, according to an embodiment.

Referring to FIG. 4, the scan trimming module 202 may remove interference data included in the scan data 301 at the current point in time. The scan trimming module 202 may set, as interference data, an overlapping portion between the main body of a mobile robot and the sensing range (or scan range) of a LiDAR sensor, which is identified in advance from the scan data of the LiDAR sensor. For example, the scan trimming module 202 may use an elevation to set, as interference data, the overlapping portion between the sensing range of the LiDAR sensor and the main body of the mobile robot. In other words, the elevation may be one of the two axes of a spherical coordinate system, an elevation and an azimuth, when LiDAR scan is visualized on the spherical coordinate system. Here, when the body (elevation 20 to 45 degrees on the spherical coordinate system) of the mobile robot is scanned in a predetermined elevation and azimuth range, the range may be regarded as interference data and trimmed.

The scan trimming module 202 may extract overlapping points scanned at a predetermined elevation or higher in a dynamic environment from a point cloud included in the scan data at the current point in time using an elevation. The scan trimming module 202 may set the overlapping points as interference data.

Additionally, the scan trimming module 202 may set, as interference data, points scanned within a predetermined distance within the sensing range of the LiDAR sensor, which is identified in advance. In other words, the scan trimming module 202 may remove, from the point cloud included in the scan data at the current point in time, predetermined points, which are identified as interference data and included in the sensing range of the LiDAR sensor, by considering external variables according to the dynamic environment. Here, external variables depending on the operating environment may be an elevation or a distance. A predetermined point may be an elevation point or a distance point depending on an external variable. For example, the scan trimming module 202 may extract, from the point cloud included in the scan data at the current point in time, elevation points scanned below a predetermined elevation in the dynamic environment. The scan trimming module 202 may extract distance points scanned at a predetermined distance or less in the dynamic environment from the elevation points by considering the position of the mobile robot at a point in time at which the scan data at the current point in time is scanned. The scan trimming module 202 may set the distance points as interference data.

Thereafter, the scan trimming module 202 may remove the interference data from the scan data at the current point in time.

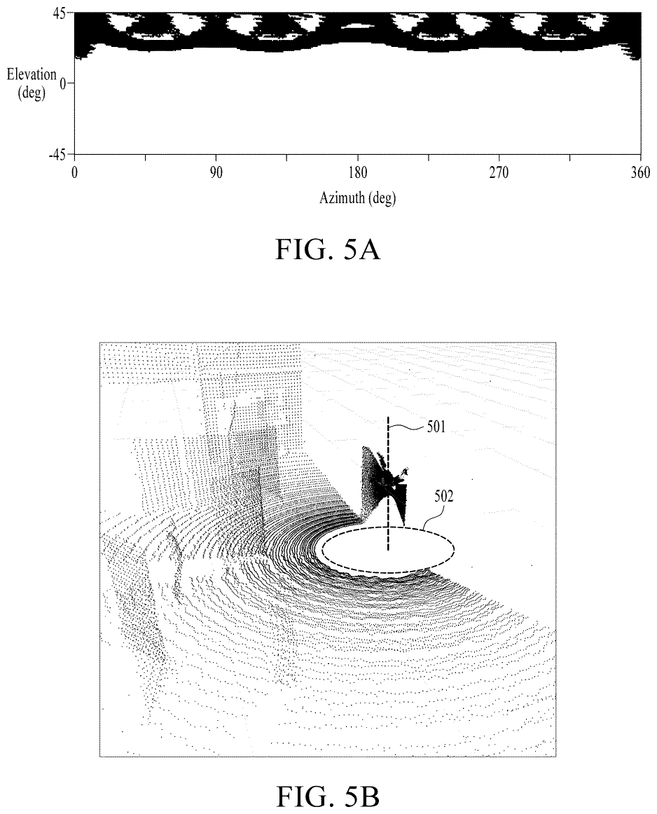

FIGS. 5A and 5B are diagrams illustrating a detailed operation of a scan trimming module, according to an embodiment.

FIGS. 5A and 5B illustrate conditions for removing interference data in the scan trimming module 202 described with reference to FIG. 4. According to the present disclosure, when there is a limitation on the size of the mobile robot 100 or a portion of the mobile robot 100 where the LiDAR sensor 101 may be installed, the main body of the mobile robot 100 and the scan range, that is, the sensing range, of the LiDAR sensor 101 may overlap each other. Such overlapping may result in an inaccurate result for a proximity environment of the LiDAR sensor 101 in the scan output, that is, the scan data, of the LiDAR sensor 101.

In general, scanning through the LiDAR sensor 101 may be for obtaining more accurate information about the surrounding environment. The scan trimming module 202 may perform a trimming process on the scan data using the LiDAR sensor 101. In other words, according to the present disclosure, it may be possible to identify an overlapping scan portion of the mobile robot and a scan portion within a predetermined distance 502 in the point cloud included in the sensor data of the LiDAR sensor 101 in advance. Here, shaded regions are generated above and below the LiDAR sensor 101. Because the closest distance or a short distance is included based on 501 the LiDAR sensor 101, it may be possible to identify the shaded regions as scan portions within the predetermined distance 502.

The scan trimming module 202 may perform an operation of setting, as interference data, an overlapping scan portion and the scan portion within the predetermined distance 502 and then outputting the sensor data by excluding the interference data from the sensor data.

For example, the scan trimming module 202 may identify an overlapping scan portion of the mobile robot in the point cloud included in the sensor data of the LiDAR sensor 101 in advance. Referring to FIG. 5A, the overlapping scan portion may be identified as points scanned at an elevation of 20° or more. The scan trimming module 202 may perform a trimming process to extract an overlapping point scanned at an elevation of 20° or more from the point cloud included in the scan data at the current point in time and remove the overlapping point.

In another example, the scan trimming module 202 may identify a scan portion within the predetermined distance in the point cloud included in the sensor data of the LiDAR sensor 101 in advance. Referring to FIG. 5B, the scan portion within the predetermined distance may be identified as a scan portion having an elevation of less than 20° in the entire sensor data of the LiDAR sensor 101 or points where the scan distance of the LiDAR sensor 101 is less than or equal to 2 meters (m). The scan trimming module 202 may perform a trimming process to remove, from the point cloud included in the scan data at the current point in time, distance points that are elevation points with an elevation of less than 20° and at the same time belong to a scan portion within the predetermined distance 502.

The scan trimming module 202 may perform a function of outputting only a more accurate portion with minimized noise among surrounding environment information of the mobile robot 100 from the scan data of the LiDAR sensor 101 through the trimming process described above.

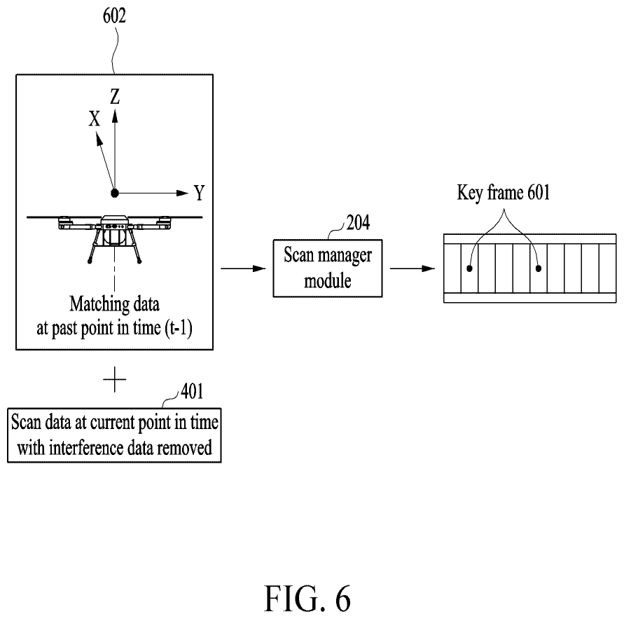

FIG. 6 is a diagram illustrating an operation of a scan manager module of a computing device, according to an embodiment.

Referring to FIG. 6, the scan manager module 204 may store and manage at least one of scan data at a current point in time with interference data removed and matching data at a past point in time. More particularly, the scan manager module 204 may store and manage scan data 401 at a current point in time t with interference data removed, wherein the scan data 401 is refined by the scan trimming module 202 according to the movement of the mobile robot 100. In addition, the scan manager module 204 may store and manage matching data generated by the scan matching module 203, that is, matching data 602 at a past point in time t-1. Here, the matching data may be a position and a posture of the LiDAR sensor 101 with respect to reference fixed coordinates (an inertial frame).

The scan manager module 204 may transmit data stored and managed through the scan manager module 204 to the proximity point manager module 205 and the scan merging module 206.

In addition, using the matching data 602 at the past point in time t−1, the scan manager module 204 may determine a key frame 601 that is a basis for the movement of the mobile robot 100 from the scan data 401 at the current point in time t with interference data removed. In other words, the scan manager module 204 may determine, from the scan data being stored and managed, the key frame 601 as reference scan to be used to generate the matching data at the current point in time in the scan matching module 203. The scan manager module 204 may transmit scan data including the key frame 601 to the scan matching module 203. Furthermore, the scan manager module 204 may transmit, to the scan matching module 203, reference scan data that may be used for scan matching in addition to a key frame. Here, the reference scan data may be raw data collected from the LiDAR sensor or scan data of the scan trimming module 202 or may include various formats that may be used for scan matching.

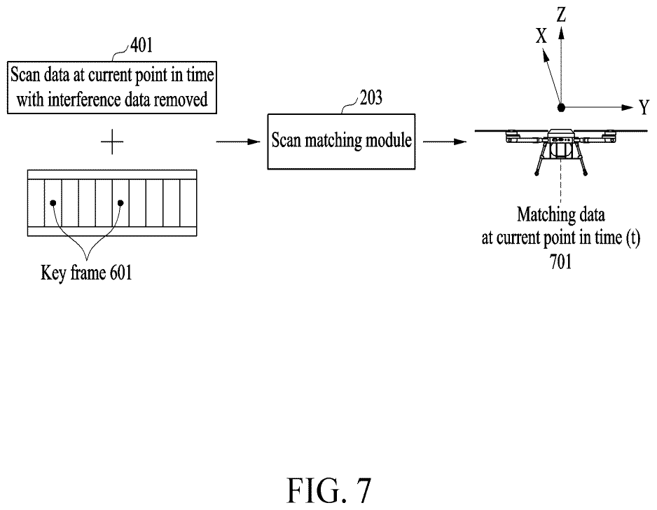

FIG. 7 is a diagram illustrating an operation of a scan matching module of a computing device, according to an embodiment.

Referring to FIG. 7, the scan matching module 203 may generate matching data at the current point in time that indicates a position and a posture of a LiDAR sensor in a reference coordinate system according to a point in time at which the LiDAR sensor collects scan data at the current point in time. Using the key frame 601 included in the scan data received from the scan manager module 204 and the scan data 401 at the current point in time with the interference data removed, wherein the scan data 401 is received from the scan trimming module 202, the scan matching module 203 may generate matching data 701 at the current point in time that indicates the position and the posture of the LiDAR sensor in the reference coordinate system. In addition, using reference scan data received from the scan manager module 204 in addition to the key frame 601, the scan matching module 203 may generate the matching data 701 at the current point in time.

In other words, the scan matching module 203 may generate the matching data 701 at the current point in time that indicates the position and the posture of the LiDAR sensor with respect to the inertial frame when the LiDAR sensor 101 scans the scan data at the current point in time.

The scan matching module 203 may match the key frame 601 with the scan data 401 at the current point in time with the received interference data removed by utilizing an iterative closest point algorithm utilized in the latest LiDAR simultaneous localization and mapping (SLAM) and an odometry implementation.

Here, the scan matching module 203 may utilize input values obtained from the other sensors 208 to increase matching accuracy. For example, the other sensors may include sensors such as an accelerometer, a gyro sensor, a magnetometer, an encoder, a camera, and the like.

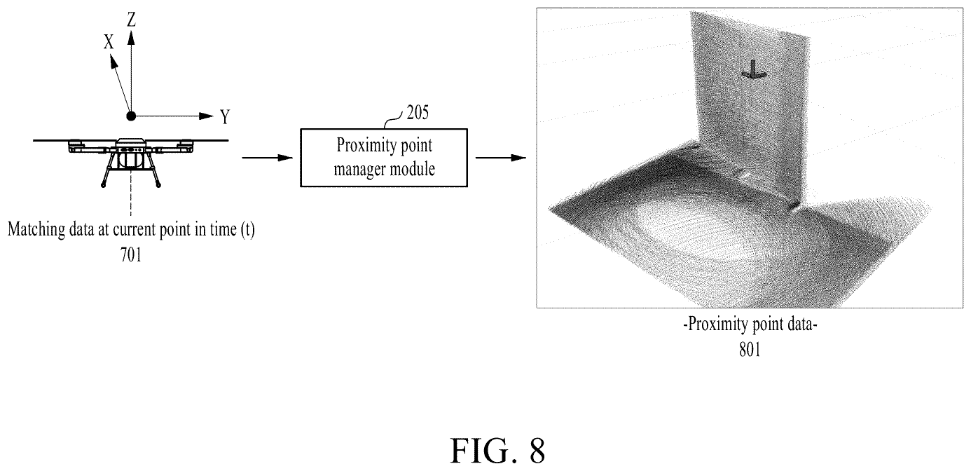

FIG. 8 is a diagram illustrating an operation of a proximity point manager module of a computing device, according to an embodiment.

Referring to FIG. 8, using the matching data 701 at the current point in time, the proximity point manager module 205 may determine proximity point data 801 included in the sensing range of the LiDAR sensor 101 according to the movement of the mobile robot 100.

More particularly, using the scan data 401 at the current point in time with interference data removed and the matching data at the current point in time, the proximity point manager module 205 may convert, into coordinates of an inertial frame system, a point cloud included in the scan data at the current point in time with the interference data removed. In other words, the proximity point manager module 205 may convert the point cloud into the coordinates of the inertial frame system only for a result scanned within a predetermined distance from the LiDAR sensor 101 at the current point in time and the past point in time.

In this case, using matching data of each of the scan data at the current point in time and the scan data at the past point in time, the proximity point manager module 205 may convert the point cloud into the coordinates of the inertial frame system.

The proximity point manager module 205 may accumulate the point cloud that is converted into the coordinates of the inertial frame system on a reference coordinate system related to the movement of the mobile robot 100. The proximity point manager module 205 may determine proximity point data 801 so that a point cloud within a predetermined range is included with respect to the position of the LiDAR sensor at the current point in time in the point cloud accumulated on the reference coordinate system.

In other words, the proximity point manager module 205 may perform a process of extracting again only points within the predetermined range with respect to the position of the LiDAR sensor 101 on the reference coordinate system. The proximity point manager module 205 may determine the proximity point data 801 through a re-extraction process.

The proximity point data 801 may be an accumulated result using only points included in a sensing range that the LiDAR sensor 101 may accurately measure as the mobile robot 100 moves within a predetermined space. In other words, the proximity point manager module 205 may derive a more precise scan result by generating the proximity point data 801 including only the results obtained by accumulating the points included in the sensing range of the LiDAR sensor 101 according to the movement distance of the mobile robot 100 from a point in time t−1 to a point in time t.

In addition, the proximity point manager module 205 may minimize the impact on accuracy even if an error occurs in the posture and position of the LiDAR sensor 101 estimated to generate matching data in the scan matching module 203 by generating not only the sensing range of the LiDAR sensor 101 but also the proximity point data 801 obtained by extracting only the points close to the sensing range. The proximity point manager module 205 may minimize the impact of a drift issue that inevitably occurs in the process of matching scan data and manage more accurate LiDAR proximity point cloud information by generating the proximity point data 801 obtained by accumulating only scan data with a driving distance less than or equal to a predetermined distance.

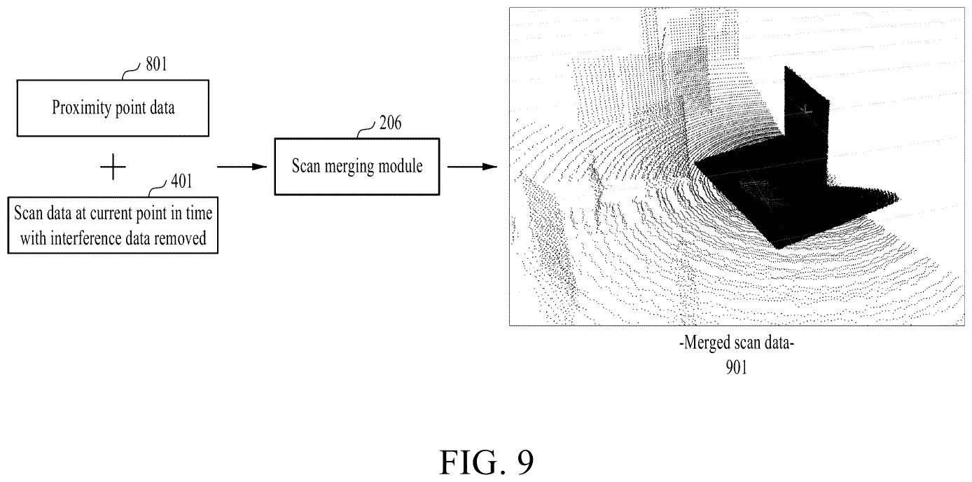

FIG. 9 is a diagram illustrating an operation of a scan merging module of a computing device, according to an embodiment.

Referring to FIG. 9, based on the matching data 701 at the current point in time, the scan merging module 206 may merge the proximity point data 801 with the scan data 401 at the current point in time with interference data removed. More particularly, the scan merging module 206 may receive the proximity point data 801 from the proximity point manager module 205. The scan merging module 206 may receive the matching data 701 at the current point in time from the scan matching module 203.

The scan merging module 206 may convert the proximity point data 801 into coordinates of a body coordinate system of the LiDAR sensor 101 by utilizing the position and the posture of the LiDAR sensor 101 included in the matching data 701 at the current point in time. The scan merging module 206 may merge a point cloud, which is included in the proximity point data 801 and converted into the coordinates of the body coordinate system of the LiDAR sensor 101, with the scan data 401 at the current point in time with interference data removed. This may be represented as a merged scan result 901.

Through this process, the scan merging module 206 may restore, to more accurate merged scan data 901, scan data that is removed by the scan trimming module 202 and inaccurate scan data adjacent to the LiDAR sensor 101.

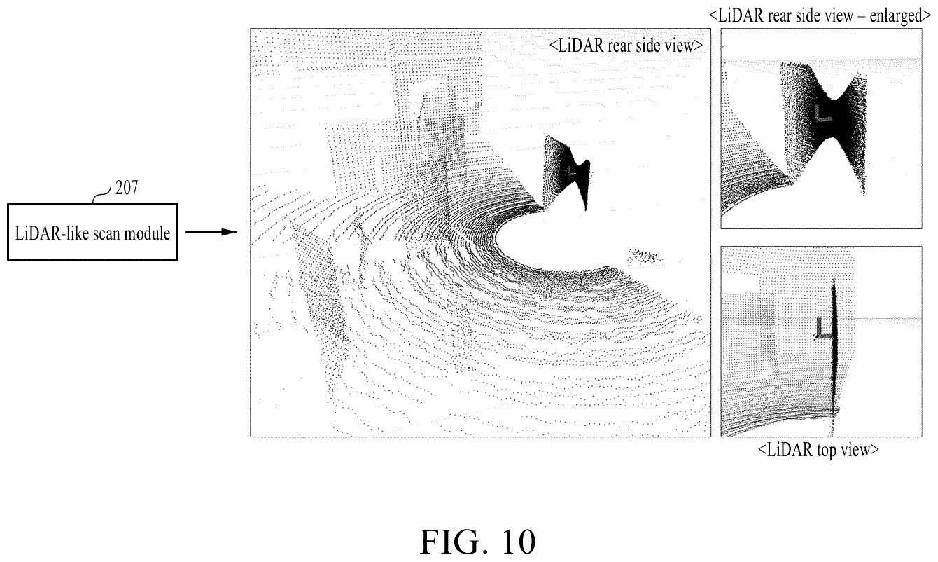

FIG. 10 is a diagram illustrating an operation of a LiDAR-like scan module of a computing device, according to an embodiment.

Referring to FIG. 10, the LiDAR-like scan module 207 may process the merged scan data 901 that is merged through the scan merging module 206 to simulate scan result data and may visually output a simulated result on a screen. In other words, the LiDAR-like scan module 207 may perform an operation of simulating the scan result data so that the merged scan data 901 generated by the scan merging module 206 appears as a result obtained through the LiDAR sensor 101.

For this, the LiDAR-like scan module 207 may convert all points of the point cloud included in the scan result data into coordinates of a spherical coordinate system. The LiDAR-like scan module 207 may assign the points, which are converted into the coordinates, of the point cloud to elevation-azimuth grids. In other words, the LiDAR-like scan module 207 may assign the points, which are converted into the coordinates, of the point cloud to the grids including elevations and azimuths set to match the specifications (intrinsic parameters) of the LiDAR sensor 101. Thereafter, using the points assigned to the elevation-azimuth grids in a one-to-one manner, the LiDAR-like scan module 207 may visually output simulated scan result data on a screen. In this case, the LiDAR-like scan module 207 may select a point closest to the origin of the body coordinate system of the LiDAR sensor 101 for each grid and output the simulated scan result data as a sensor value based on the selected point.

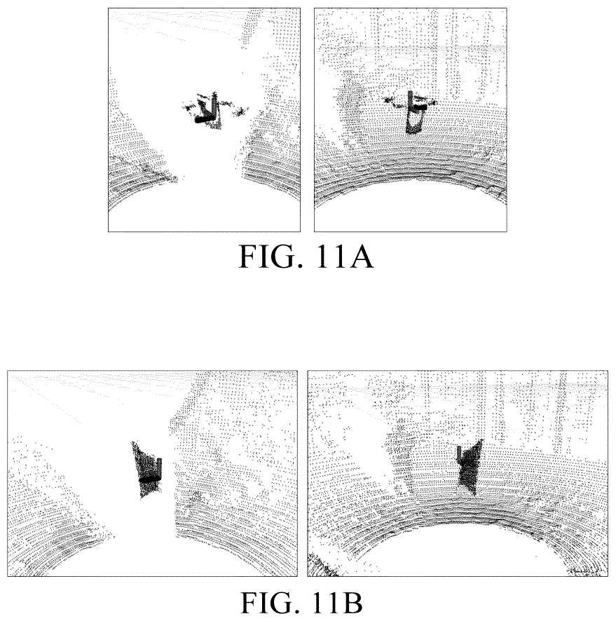

FIGS. 11A and 11B are diagrams illustrating results provided through a LiDAR-like scan module, according to an embodiment.

The results illustrated in FIGS. 11A and 11B are outputs that simulate the scan result data 901 generated by the scan merging module 206, as if the scan result data 901 is obtained through the LiDAR sensor 101 in the LiDAR-like scan module 207.

FIG. 11A illustrates a result of scan data scanned through the LiDAR sensor 101 that moves while mounted on the mobile robot 100. FIG. 11B illustrates a result derived by applying the scan data scanned through the LiDAR sensor 101 to the LiDAR sensing method of the present disclosure.

According to a comparison between FIGS. 11A and 11B, it may be possible to obtain LiDAR scan information that is more accurate than the scan data obtained from the LiDAR sensor 101 even when the mobile robot 100 equipped with the LiDAR sensor 101 flies adjacent to an obstacle existing in a predetermined space.

This LiDAR sensing method of the present disclosure is a method of improving the sensing accuracy of the LiDAR sensor 101 for a nearby object. This method may improve the LiDAR scan accuracy of the LiDAR sensor 101 for a nearby obstacle.

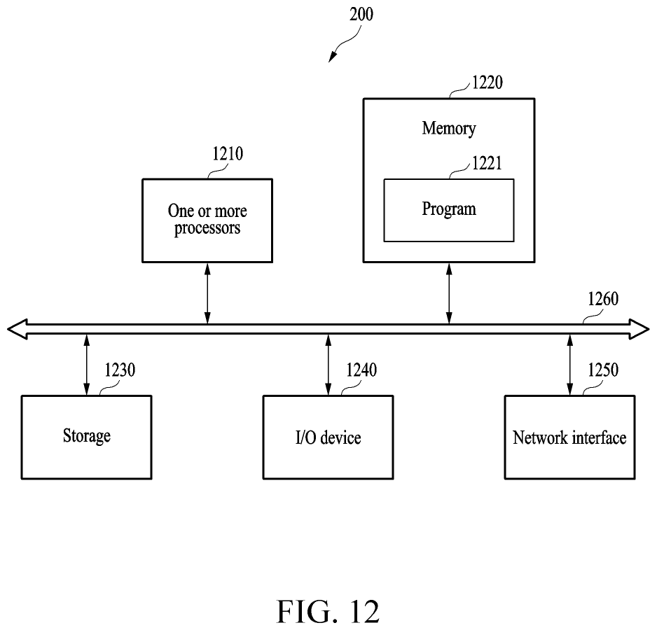

FIG. 12 is a block diagram illustrating an example of a configuration of a computing device included in a LiDAR sensor, according to an embodiment.

Referring to FIG. 12, a computing device 200 may include one or more processors 1210, a memory 1220, a storage 1230, an input/output (I/O) device 1240, and a network interface 1250. These components may communicate with one another via a communication bus 1260.

The one or more processors 1210 may execute instructions stored in the memory 1220 or the storage 1230. The instructions, when executed by the one or more processors 1210, may cause the computing device 1200 to perform the operations described with reference to FIGS. 1 to 11. The memory 1220 may include a computer-readable storage medium or a computer-readable storage device. The memory 1220 may store instructions to be executed by the one or more processors 1210 and may store related information while software and/or an application is being executed by the computing device 1200. The memory 1220 may store a simulation program 1221 configured to perform a warpage simulation in an embodiment. When at least a portion of the simulation program 1221 is stored in the memory 1220, the operations described with reference to FIGS. 1 to 11 may be performed by the computing device 1200.

The storage 1230 may include a computer-readable storage medium or a computer-readable storage device. The storage 1230 may store a larger amount of information than the memory 1220 for a long time. For example, the storage 1230 may include a magnetic hard disk, an optical disc, flash memory, a floppy disk, or other non-volatile memories known in this technical field.

The I/O device 1240 may receive an input from a user in traditional input manners through a keyboard and a mouse, and in new input manners such as a touch input, a voice input, and an image input. For example, the I/O device 1240 may include a keyboard, a mouse, a touch screen, a microphone, or any other device that detects the input from the user and transmits the detected input to the computing device 1200. The I/O device 1240 may provide the user with an output of the computing device 1200 through a visual channel, an audio channel, or a tactile channel. The I/O device 1240 may include, for example, a display, a touch screen, a speaker, a vibration generator, or any other device that provides the output to the user. The network interface 1250 may communicate with an external device through a wired or wireless network.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A computing device comprising:
a light detection and ranging (LiDAR) sensor module configured to collect scan data at a current point in time scanned through a LiDAR sensor mounted on a mobile robot;
a scan trimming module configured to remove interference data comprised in the scan data at the current point in time;
a scan manager module configured to manage at least one of the scan data at the current point in time with the interference data removed and matching data at a past point in time;
a scan matching module configured to generate matching data at a current point in time that indicates a position and a posture of the LiDAR sensor in a reference coordinate system according to a point in time at which the LiDAR sensor collects the scan data at the current point in time;
a proximity point manager module configured to determine, using the scan data at the current point in time with the interference data removed, proximity point data comprised in a sensing range with respect to the position of the LiDAR sensor;
a scan merging module configured to merge, based on the matching data at the current point in time, the proximity point data with the scan data at the current point in time with the interference data removed; and
a LiDAR-like scan module configured to process merged scan data to simulate scan result data and visually output a simulated result on a screen.

2. The computing device of claim 1, wherein the LiDAR sensor module i configured to collect, from the LiDAR sensor, scan data at a current point in time obtained by scanning a dynamic environment that changes according to movement of the mobile robot within a sensing range of the LiDAR sensor.

3. The computing device of claim 2, wherein the scan trimming module is configured to remove, from a point cloud comprised in the scan data at the current point in time, an overlapping point, which is identified as interference data, between a main body of the mobile robot and sensor data of the LiDAR sensor.

4. The computing device of claim 2, wherein the scan trimming module is configured to remove, from a point cloud comprised in the scan data at the current point in time, a predetermined point, which is identified as interference data and comprised in the sensing range of the LiDAR sensor, by considering an external variable according to the dynamic environment.

5. The computing device of claim 1, wherein the scan matching module is configured to generate matching data at a current point in time that indicates the position and the posture of the LiDAR sensor for reference fixed coordinates (an inertial frame) when the LiDAR sensor scans the scan data at the current point in time.

6. The computing device of claim 1, wherein the proximity point manager module is configured to:
using the scan data at the current point in time with the interference data removed and the matching data at the current point in time, convert, into coordinates of a reference fixed coordinate (inertial frame) system, a point cloud comprised in the scan data at the current point in time with the interference data removed and accumulate the point cloud on a reference coordinate system; and
determine proximity point data by extracting a point cloud within a predetermined range with respect to the position of the LiDAR sensor in the reference coordinate system on which the point cloud is accumulated.

7. The computing device of claim 6, wherein the proximity point manager module is configured to:
using the matching data at the current point in time, determine the position of the LiDAR sensor at a point in time at which the LiDAR sensor collects the scan data at the current point in time; and
determine proximity point data such that a point cloud is comprised in a preset or predetermined range with respect to the position of the LiDAR sensor on the reference coordinate system on which the converted point cloud is accumulated.

8. The computing device of claim 6, wherein the proximity point manager module is configured to extract, from the scan data at the current point in time with the interference data removed and scanned when a driving distance of the mobile robot is less than or equal to a preset or predetermined distance among the scan data at the current point in time with the interference data removed, a point cloud, convert the point cloud into the coordinates of the inertial frame system, and accumulate the point cloud on the reference coordinate system.

9. The computing device of claim 1, wherein the scan merging module is configured to:
using the matching data at the current point in time, determine the position and the posture of the LiDAR sensor at the current point in time;
convert a point cloud comprised in the proximity point data into coordinates of a body coordinate system of the LiDAR sensor according to the position and the posture of the LiDAR sensor at the current point in time; and
generate scan result data by merging the scan data at the current point in time with the interference data removed with the point cloud converted into the coordinates of the body coordinate system of the LiDAR sensor.

10. The computing device of claim 1, wherein the LiDAR-like scan module is configured to:
convert a point cloud comprised in the scan result data into coordinates of a spherical coordinate system;
assign points comprised in the point cloud, which is converted into the coordinates of the spherical coordinate system, to elevation-azimuth grids in a one-to-one manner, wherein the elevation-azimuth grids are set as specifications (intrinsic parameters) of the LiDAR sensor; and
using the points assigned to the elevation-azimuth grids in a one-to-one manner, visually output the scan result data on a screen.

11. A mobile robot comprising:
a main body;
a light detection and ranging (LiDAR) sensor mounted on a first predetermined region of the main body; and
other sensors mounted on a second predetermined region of the main body,
wherein the LiDAR sensor is configured to derive, visually compensate for, and output scan data of a shaded region that is possibly generated in a sensing range of the LiDAR sensor by scanning scan data at a current point in time in a dynamic environment that changes according to movement of the mobile robot.

12. The mobile robot of claim 11, wherein
the LiDAR sensor comprises a computing device comprising a processor, and
the processor comprises:
a LiDAR sensor module configured to collect scan data at a current point in time scanned through the LiDAR sensor mounted on the mobile robot;
a scan trimming module configured to remove interference data comprised in the scan data at the current point in time;
a scan manager module configured to manage at least one of the scan data at the current point in time with the interference data removed and matching data at a past point in time;
a scan matching module configured to generate matching data at a current point in time that indicates a position and a posture of the LiDAR sensor in a reference coordinate system according to a point in time at which the LiDAR sensor collects the scan data at the current point in time;
a proximity point manager module configured to determine, using the scan data at the current point in time with the interference data removed, proximity point data comprised in a sensing range with respect to the position of the LiDAR sensor according to the movement of the mobile robot;
a scan merging module configured to merge, based on the matching data at the current point in time, the proximity point data with the scan data at the current point in time with the interference data removed; and
a LiDAR-like scan module configured to process merged scan data to simulate scan result data and visually output a simulated result on a screen.

13. A light detection and ranging (LiDAR) sensing method performed by a computing device, the LiDAR sensing method comprising:
collecting scan data at a current point in time at which a dynamic environment that changes according to movement of a mobile robot is scanned within a sensing range of a LiDAR sensor through the LiDAR sensor mounted on the mobile robot;
removing interference data comprised in the scan data at the current point in time;
storing and managing at least one of the scan data at the current point in time with the i nterference data removed and matching data at a past point in time;
generating matching data at a current point in time that indicates a position and a posture of the LiDAR sensor in a reference coordinate system according to a point in time at which the LiDAR sensor collects the scan data at the current point in time;
using the scan data at the current point in time with the interference data removed, determining proximity point data comprised in a sensing range with respect to the position of the LiDAR sensor according to the movement of the mobile robot;
based on the matching data at the current point in time, merging the proximity point data with the scan data at the current point in time with the interference data removed; and
processing merged scan data to simulate scan result data and visually outputting a simulated result on a screen.

14. The LiDAR sensing method of claim 13, wherein the removing of the interference data comprises removing, from a point cloud comprised in the scan data at the current point in time, an overlapping point, which is identified as interference data, between a main body of the mobile robot and sensor data of the LiDAR sensor.

15. The LiDAR sensing method of claim 13, wherein the removing of the interference data comprises removing, from a point cloud comprised in the scan data at the current point in time, a predetermined point comprised in a sensing range of the LiDAR sensor and identified as interference data by considering an external variable according to the dynamic environment.

16. The LiDAR sensing method of claim 13, wherein the generating of the matching data at the current point in time comprises generating the matching data at the current point in time that indicates a position and a posture of the LiDAR sensor for reference fixed coordinates (an inertial frame) when the LiDAR sensor scans the scan data at the current point in time.

17. The LiDAR sensing method of claim 13, wherein the determining of the proximity point data comprises:
using the matching data at the current point in time, determining the position of the LiDAR sensor at a point in time at which the LiDAR sensor collects the scan data at the current point in time;
using the scan data at the current point in time with the interference data removed and the matching data at the current point in time, converting, into coordinates of a reference fixed coordinate (inertial frame) system, a point cloud comprised in the scan data at the current point in time with the interference data removed and accumulating the point cloud on a reference coordinate system; and
determining proximity point data so that a point cloud within a preset or predetermined range with respect to the position of the LiDAR sensor is included in the reference coordinate system on which the point cloud is accumulated.

18. The LiDAR sensing method of claim 17, wherein the determining of the proximity point data comprises extracting, from the scan data at the current point in time, with the interference data removed, scanned when a driving distance of the mobile robot is less than or equal to a preset or predetermined distance among the scan data at the current point in time with the interference data removed, a point cloud, converting the point cloud into the coordinates of the inertial frame system, and accumulating the point cloud on the reference coordinate system.

19. The LiDAR sensing method of claim 13, wherein the generating of the scan result data comprises:
using the matching data at the current point in time, determining a position and a posture of the LiDAR sensor at the current point in time;
converting a point cloud comprised in the proximity point data into coordinates of a body coordinate system of the LiDAR sensor according to the position and the posture of the LiDAR sensor at the current point in time; and
generating the scan result data by merging the point cloud converted into the coordinates of the body coordinate system of the LiDAR sensor with the scan data at the current point in time with the interference data removed.

20. The LiDAR sensing method of claim 13, wherein the outputting of the simulated result comprises:
converting the point cloud comprised in the scan result data into coordinates of a spherical coordinate system;
assigning points comprised in the point cloud, which is converted into the coordinates of the spherical coordinate system, to elevation-azimuth grids in a one-to-one manner, wherein the elevation-azimuth grids are set as specifications (intrinsic parameters) of the LiDAR sensor; and
using the points assigned to the elevation-azimuth grids in a one-to-one manner, visually outputting the scan result data on a screen.
